(19) United States
(12) Patent Application Publication
(10) Pub. No.: US 2024/0068535 A1
(43) Pub. Date: Feb. 29, 2024

(54) PAD RETAINER ASSEMBLY, BRAKE CALIPER ASSEMBLY, DISC BRAKE AND DISC BRAKE MONITORING SYSTEM

(71) Applicant: SAF-HOLLAND GmbH, Bessenbach (DE)

(72) Inventor: Ralf Aumüller, Frankfort (DE)

(21) Appl. No.: 18/259,490

(22) PCT Filed: Jan. 25, 2022
(86) PCT No.: PCT/EP2022/051535

§ 371 Date: Jun. 27, 2023

(30) Foreign Application Priority Data
Feb. 2, 2021 (DE) 10 2021 102 324.6

(51) Int. Cl. F16D 65/095; F16D 65/00

(52) U.S. Cl. CPC F16D 65/095; F16D 65/0068; F16D 2066/001

(57) ABSTRACT

A brake pad retainer assembly for a brake caliper assembly, in particular for a commercial vehicle brake caliper assembly, includes a retaining element and a sensor element, wherein the retaining element extends in a longitudinal direction, and wherein the sensor element is fixed or configured to be fixed indirectly and/or directly to the retaining element.

### BACKGROUND

The invention relates to a pad retainer assembly, a brake caliper assembly, a disc brake, and a disc brake monitoring system.

Monitoring the condition of a disc brake is already known from the prior art. For this purpose, a sensor element is usually integrated into the brake pad, which is intended to or can detect the state of wear of the brake pad. However, the problem with these systems for monitoring the condition of the disc brake system, which are already known from the prior art, is that the entire brake pad has to be replaced if the sensor fails and that the brake pads required for such systems are very expensive.

It is therefore the object of the present invention to provide a means of monitoring a disc brake which is inexpensive and does not require a great deal of assembly work.

### SUMMARY

According to the invention, there is a brake pad retainer assembly for a brake caliper assembly. In particular, the brake pad retainer assembly may be designed for a commercial vehicle brake caliper assembly. In particular, the brake pad retainer assembly comprises a retaining element and a sensor element. The retaining element advantageously extends in a longitudinal direction, wherein the sensor element may be fixed or fixable indirectly and/or directly to the retaining element. The brake pad retainer assembly according to the invention thereby serves to be arranged in a brake caliper assembly in such a way that a set of brake pads are fixed in their final installation position by the brake pad retainer assembly. Such a brake caliper assembly thereby serves to be able to receive brake pads, which can each be arranged laterally of a brake disc, so that the brake disc can be braked by these brake pads. Advantageously, the brake pad retainer assembly is designed such that it can be used in a commercial vehicle brake caliper assembly. A commercial vehicle in the sense of the invention is in particular a roadworthy vehicle with a gross vehicle weight of more than 3.5 t, preferably of more than 7.5 t and particularly strongly preferred of more than 15 t. Therefore, a commercial vehicle brake caliper assembly differs fundamentally in its dimensioning from a motor vehicle brake caliper assembly. The brake pad retainer assembly according to the invention comprises at least one retaining element and one sensor element. The retaining element of the brake pad retainer assembly is used to hold down a brake pad directly or indirectly in a form-fitting manner or to prevent it from escaping from a brake caliper in a form-fitting manner. The retaining element extends in a longitudinal direction. This longitudinal direction of the retaining element is advantageously the direction in which the retaining element has its largest longitudinal dimension and/or in which the retaining element has its largest main dimension. In other words, the longitudinal direction may therefore be the direction in which the length of the retaining element is dimensioned. Alternatively or additionally preferably, the longitudinal direction may also be oriented parallel to the axis of rotation of the axis to be braked, particularly in a mounted condition in a brake caliper. In addition to the retaining element, the brake pad retainer assembly also has a sensor element, advantageously a plurality of sensor elements, which are or can be fixed indirectly and/or directly to the retaining element. The sensor element serves to detect a measured value. For example, this measured value can be a temperature, a vibration and/or a force. Advantageously, the sensor element or all sensor elements operate without contact. This allows a measured value to be determined by the sensor element in a particularly low-wear manner. Alternatively or additionally preferably, at least one of the sensor elements can also use a contacting measuring principle. By a fixing it is to be understood in particular that the sensor element is fixed, in particular stationary, to the retaining element. Alternatively or additionally preferably, being fixed can also be understood to mean that the weight force of the sensor element is derived or can be derived via the retaining element. Therefore, the sensor element may be held, in particular exclusively, by the retaining element. By arranging the sensor element on the retaining element or by fixing the sensor element on the retaining element, a particularly space-saving and compact brake pad retainer assembly can be achieved which, moreover, is also particularly inexpensive and allows the sensor to be replaced in a simple manner. It is expedient for this sensor element to be fixed to the retaining element by means of a cable tie or a clip element. Alternatively or additionally preferably, this fixing can also be effected by reversible fixing means, such as screws or bolts or similar means. This can ensure particularly easy disassembly. If a particularly durable fixing is to be achieved, irreversible fixing means, such as rivets, adhesive or welding, can be used.

In a preferred embodiment, the retaining element has a primary retaining area and a secondary retaining area, wherein the primary retaining area and the secondary retaining area are designed to support the retaining element relative to a brake caliper or a brake caliper assembly, and wherein the sensor element is arranged, in particular in the longitudinal direction, between the primary retaining area and the secondary retaining area. The primary retaining area and the secondary retaining area therefore serve to support the retaining element relative to a brake caliper or a brake caliper assembly. Expediently, the primary retaining area and/or the secondary retaining area can form distal ends of the retaining element, in particular as viewed in the longitudinal direction. In this way, a particularly simple assembly can be achieved. The primary retaining area is in particular that area of the retaining element or that retaining area (primary or secondary retaining areas) of the retaining element which faces a possible brake cylinder of a brake caliper assembly. The secondary holding area of the retaining element, on the other hand, can in particular be that area which forms a distal end opposite the brake cylinder, in particular in the longitudinal direction. The primary retaining area and/or the secondary retaining area, which may also be referred to as primary and secondary retaining areas, respectively, may or may not be insertable into an opening of a brake caliper, which advantageously extends along or at least substantially parallel to the longitudinal direction. Alternatively or additionally preferably, the primary retaining area and/or the secondary retaining area may also be connected to or fixed to a brake caliper or caliper assembly via bolt connections and/or via clamping inserts. Expediently, the sensor element is arranged, in particular in the longitudinal direction, between the primary retaining area and the secondary retaining area. In this way, a particularly effective measuring arrangement can be achieved, because the arrangement of the sensor element, in particular in the longitudinal direction, between the primary retaining area and the secondary retaining area means that the sensor element can be arranged particularly close to a brake disc or a brake pad. In addition, this can also result in a particularly space-saving and low-maintenance assembly or fixing of the sensor element to the retaining element, because this assembly can increase the accessibility of the sensor element.

Expediently, the retaining element is a pad retainer bar. A pad retainer bar is used in particular to hold down brake pads in a brake caliper assembly or to prevent them from escaping from the brake caliper. The pad retainer bar advantageously extends parallel to the axis of rotation to be braked. Expediently, the pad retainer bar is advantageously a sheet metal and/or cast construction. This makes it possible to achieve a particularly resilient design for a retaining element.

Advantageously, at least one of the sensor elements, preferably all sensor elements, is a temperature measurement sensor and/or a contactless sensor. By providing a temperature measurement sensor, conclusions can be drawn in a simple manner about the braking situation of an axis to be braked. For example, an overload and/or a malfunction of the brake can be detected. By providing a contactless sensor, a particularly low-wear sensor design can be achieved. Such a contactless sensor can, for example, make use of the imitated thermal radiation of a brake pad, a brake disc and/or a brake caliper. In this context, a contactless sensor means in particular that the sensor element does not make contact with or touch the elements whose measured values are to be recorded in order to record a measured value.

Advantageously, the sensor element is connected to a cable arrangement, the cable arrangement being fastened in particular to the retaining element, preferably by means of clips or cable ties. The use of a cable arrangement makes it possible to supply power to a sensor element and reliably transmit the sensed measured values in a simple and safe manner. This is particularly decisive in the field of commercial vehicle brakes, which have a high metallic content for safe support or for safe absorption of braking torques and braking forces, because this can in particular reduce the interference occurring in the case of measured value transmission taking place wirelessly. Advantageously, the cable arrangement is attached to the retaining element. In other words, the retaining element can not only be used to support the sensor element, but in addition the retaining arrangement can also be used to support or guide the cable arrangement, so that a particularly space-saving and multifunctional brake pad retainer assembly can be achieved here. This fixing of the cable arrangement can take place, for example, by making use of clips or cable ties. This makes it possible to fix the cable arrangement to the retaining element in a particularly simple and cost-effective manner.

Another aspect of the invention may relate to a brake caliper assembly, wherein the brake caliper assembly comprises a brake caliper and a brake pad retainer assembly, in particular a brake pad retainer assembly as described above and below. By using a brake pad retainer assembly in a brake caliper, the advantages and features and embodiments of a brake pad retainer assembly described above and below can be achieved or provided, in particular in a commercial vehicle brake caliper assembly. A brake caliper assembly serves in particular to be used in a disc brake for braking the brake disc present in the disc brake by means of brake pads, which can be mounted in such a brake caliper assembly.

In an advantageous embodiment, the brake caliper has an insertion opening for inserting brake pads, wherein the retaining element is mounted or mountable on the brake caliper in such a way, in particular by means of its primary retaining area and/or its secondary retaining area, that the insertion or removal of brake pads from or into the insertion opening of the brake caliper is prevented in a form-fitting manner by the retaining element. In other words, the retaining element can be mounted on the brake caliper in such a way that form-fitting insertion and removal of brake pads from the insertion opening of the brake caliper provided for this purpose is prevented by form-fitting direct or indirect contact between the brake pads and the retaining element. The insertion opening of the brake caliper is designed in particular so that, in a dismantled state of the retaining element, it is possible to insert brake pads into the brake caliper in such a way that the brake pads can take their final position, it not being necessary for this purpose to displace and/or dismantle the brake caliper in relation to the axis to be braked or to the axis of rotation of the brake disc. This can be achieved in particular, for example, by means of an insertion opening which extends perpendicularly to the longitudinal direction and/or to the axis to be braked or to the axis of rotation of the brake disc. The final position of the brake pads is thereby the position which they have in a mounted state, wherein in a mounted state the brake pads are displaceably held in the brake caliper, in particular by brake pistons, in such a way that they can make contact with a brake disc in order to achieve a frictional torque or braking torque. However, should the retaining element be mounted on the brake caliper, in this mounted state a form-fitting entry and exit of brake pads into or out of the insertion opening is prevented by the retaining element. Advantageously, the retaining element therefore spans the insertion opening. Expediently, therefore, in an assembled state the primary retaining area is fixed on one side of the insertion opening on the brake caliper and the secondary retaining area of the retaining element is fixed on the opposite side of the insertion opening, in particular as seen in the longitudinal direction. This makes it particularly easy to prevent brake pads from escaping from the insertion opening in a form-fitting manner.

Advantageously, the brake caliper assembly has at least two brake pads. This makes it possible to create a braking option in a particularly simple manner. Brake pads in the sense of the invention are in particular those brake pads which are designed to make contact with a brake disc or to form a frictional torque. Therefore, the brake pads have in particular a friction surface which is expediently located in a plane. The normal of this plane is advantageously oriented at least substantially parallel to the longitudinal direction of the retaining element and/or to the axis of rotation of the brake disc to be braked. By a substantially parallel it is to be understood that the smaller angle enclosed between the two directions may have a maximum of 100, preferably a maximum of 5, particularly preferably a maximum of 2° and very particularly preferably a maximum of 1°. However, it is particularly preferred if the directions are not only substantially parallel but exactly parallel to each other. In this way, a particularly compact and space-saving brake caliper assembly can be achieved.

It is expedient that the sensor element is arranged on the side of the retaining element facing the brake pads. In other words, the sensor element can be arranged or fixed to the retaining element in such a way that it is arranged between the retaining element and the brake pads. By facing is to be understood that the side of the retaining element on which the sensor element is arranged has a normal portion which is oriented at least in the direction of the brake pads. The arrangement is made in particular in such a way that the retaining element supports the sensor element or supports it against gravity. Advantageously, the sensor element is supported on the retaining element by a bearing element, in particular a cable tie or clamp. Advantageously, the sensor element contacts the retaining element in order to achieve a particularly secure and compact arrangement.

In an advantageous embodiment, the brake caliper assembly has a wear sensor, wherein the wear sensor measures or can detect a state of wear of the brake pads. Such a wear sensor can, for example, be installed in the brake pads, wherein advantageously the wear sensor uses an abrasive sensor principle to measure the wear condition of the brake pad or brake pads. By an abrasive measuring principle in the sense of the invention it is to be understood that in particular an internal resistance of the wear sensor changes due to a material removal of the brake pads and/or the wear sensor. For example, this can be achieved by the fact that contacts of the wear sensor are severed by the frictional contact between the brake disc and the brake pads with increasing wear. This allows conclusions to be drawn about the state of wear of the brake pad in a particularly reliable manner from a metrological point of view. By providing a wear sensor, comprehensive monitoring can be achieved in an effective manner not only by means of the sensor element on the retaining element, but also by further sensors of the brake caliper assembly, so that a reliable determination of the condition of the brake caliper assembly or the brake pads can be made.

Advantageously, the wear sensor is arranged directly or indirectly on the brake pad. In this context, the term “arranged” can be understood not only as meaning that the wear sensor is mounted on the brake pad, but also, or alternatively preferably, as meaning that the wear sensor is included in the friction material of the brake pad or is at least partially enclosed by it. In this way, a particularly space-saving arrangement of the wear sensor can be achieved, so that valuable installation space can be saved.

Expediently, the wear sensor is connected to a cable, wherein the cable can be attached to the retaining element. In other words, the wear sensor can be supplied with power by cable and/or transmit its measured values by cable—for example to an evaluation unit. In order to hold the cable of the wear sensor in a particularly space-saving manner, the latter is advantageously fastened to the retaining element, for example by clips or by cable ties. The cable is preferably arranged on the side of the retaining element facing the brake pads, particularly preferably at least in sections or completely in an area between the primary retaining area and the secondary retaining area. In this way, the cable can be particularly well protected against external damage. Alternatively or additionally preferably, the cable is arranged on the side of the retaining element facing away from the brake pads, particularly preferably at least in sections or completely in an area between the primary retaining area and the secondary retaining area. In this way, particularly good shielding against high temperatures can be achieved.

It is expedient that the cable is part of the cable assembly. This can also save valuable installation space and, in addition, it can also save on fasteners.

Advantageously, the sensor element is a brake pad temperature measuring element and/or a brake disc temperature measuring element. A brake pad temperature measuring element means in particular that the sensor element is able to detect a temperature of the brake pad in an installed state, in particular directly. In this way, it can be determined in a particularly effective manner by the sensor element whether the brake pad monitored by measurement provides sufficient dissipation energy and/or is thermally overstressed or overloaded, as the case may be. Alternatively or additionally preferably, the sensor element can also be a brake disc temperature measuring element. In other words, the sensor element can therefore also be used to measure a brake disc temperature. In this way, conclusions can be drawn about the total dissipation energy in a disc brake in a particularly simple manner and in a particularly fast manner. This information can be incorporated into and/or transmitted to a warning system and/or a wear information system of a vehicle.

A further aspect of the invention may relate to a disc brake comprising a brake disc and a brake caliper assembly, in particular as described above and below. Hereby, the aforementioned and subsequently described advantages, features and embodiments can be realized in a brake disc in a particularly effective manner.

Advantageously, the disc brake is a commercial vehicle disc brake. In other words, the disc brake may be designed and intended to find application in a commercial vehicle. Such a commercial vehicle disc brake is therefore capable of braking a commercial vehicle according to the invention. Particularly preferably, the commercial vehicle may be a trailer or a semi-trailer.

Another aspect of the invention may relate to a disc brake monitoring system. This disc brake monitoring system comprises in particular a disc brake as described above and below and/or an evaluation unit, wherein the evaluation unit is adapted to output and/or display a warning when the temperature of the brake disc and/or a brake pad is below an expected temperature and/or above an expected temperature. The expected temperature can be determined in particular by a model and/or using a neural network. For this purpose, in particular learning data are used, which are determined from or at a structurally identical proper disc brake. It is expedient to determine these learning data during a minimum load, a normal load and a maximum load condition. The evaluation unit of the disc brake monitoring system is connected, in particular in terms of information technology, to the sensor element or all sensor elements and/or to the wear sensor, so that the measured values determined in these sensor units are or can be fed to the evaluation unit. By comparing the sensor values actually present with the expected sensor values, the evaluation unit is able to achieve a comparison of the actual state with an expected target state. If there is a deviation, in particular one that exceeds a defined threshold value, the evaluation unit can output and/or display a warning. For this purpose, the evaluation unit can have an information output, for example in the context of an information display, and/or an information technology connection to a commercial vehicle. In this way, monitoring of a disc brake can be achieved in a particularly effective manner, so that possible overload conditions can be detected at an early stage and communicated to a driver. In addition, the disc brake monitoring system according to the invention can also be used to alert a user, for example, that the use of additional braking systems, such as electric braking systems for recuperation and/or retarders, in particular of the commercial vehicle, should be used more frequently in order to prevent overloading of the disc brake system.

### BRIEF DESCRIPTION OF THE DRAWINGS

Further advantages and features of the present invention result from the following description with reference to the figures. Individual features of the embodiment shown can thereby also be used in other embodiments, unless this has been expressly excluded. Showing:

FIG. 1 is a disc brake;

FIG. 2 is a section through a retaining element; and

FIG. 3 is a perspective view of a brake caliper assembly.

### DETAILED DESCRIPTION

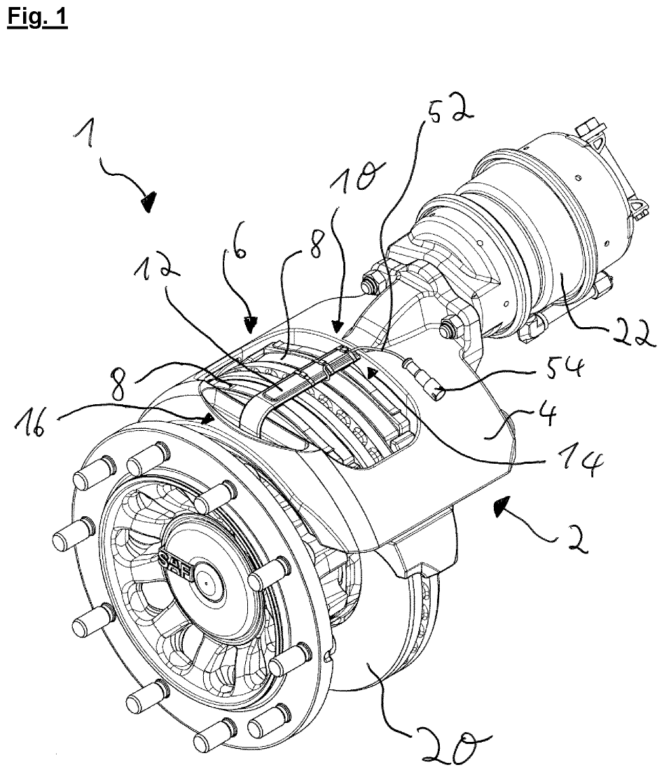

FIG. 1 shows a disc brake 1. The disc brake 1 has a brake disc 20 which is rotatably mounted about an axis of rotation to be braked. In order to brake this brake disc 20, brake pads 8 are arranged in the brake caliper 4 of the brake caliper assembly 2 of the disc brake 1. The brake pads 8 can be inserted into the brake caliper 4 through the insertion opening 6 of the brake caliper 4. In order to positively prevent the brake pads 8 from escaping from the insertion opening 6, the brake caliper assembly 2 has a retaining element 12 which spans the insertion opening 6 in the longitudinal direction L. The longitudinal direction L is not drawn in FIG. 1, although this is oriented parallel to the axis of rotation of the brake disc 20. The retaining element 12 is connected to the brake caliper 4 via its secondary retaining area 16 and via its primary retaining area 14. The primary retaining area 14 and the secondary retaining area 16 thereby form distal ends of the retaining element 12 along the longitudinal direction L. The retaining element 12 and a sensor element 50, which is not visible in FIG. 1, thereby form a brake pad retainer assembly 10. In FIG. 1, the sensor element 50 is arranged in such a way that it is arranged on the retaining element 12 on the side facing the brake pads 8, so that it cannot be seen in FIG. 1. In the situation shown, the retaining element 12 is a pad retaining bracket. In order to supply the sensor element 50 with energy, this is connected to a cable arrangement 52, which is equipped with or connected to a cable connector 54. The cable arrangement 52 is fixed to the retaining element 12 via cable ties. In order to bring the brake pads 8 into frictional contact with the brake disc 20, the disc brake 1 has a brake cylinder 22.

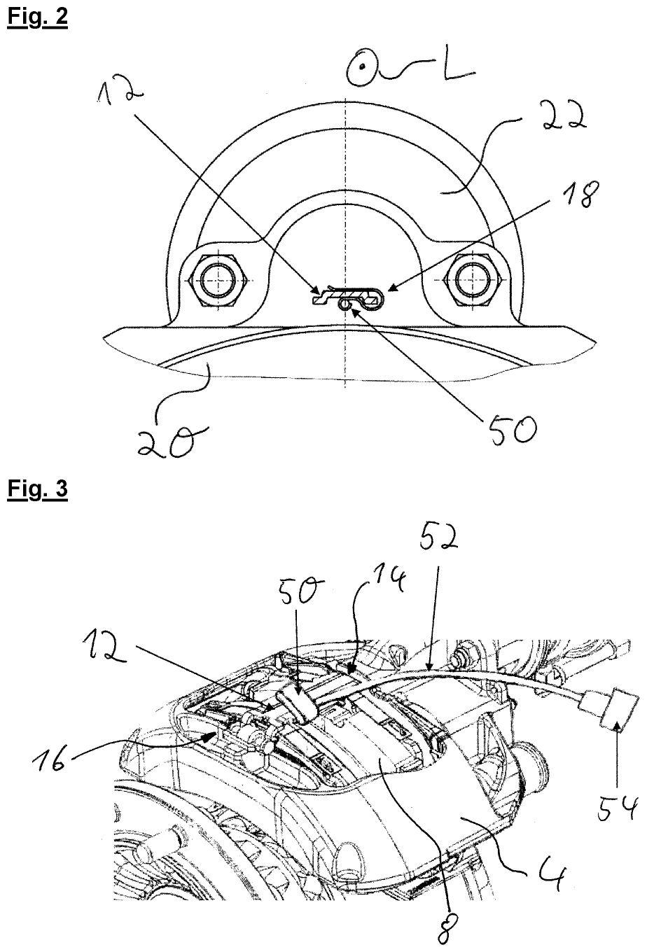

FIG. 2 shows a section through a disc brake 1. The sectional plane runs perpendicular to the longitudinal direction L. In FIG. 2, the sectional plane is arranged in such a way that it corresponds to a friction plane of the brake disc 20. The retaining element 12 extends along the longitudinal direction L, wherein a sensor element 50 is fixed to the retaining element 12 via a clip 18. The sensor element 50 is arranged on the side of the retaining element 12 facing the brake pads 8 or the brake disc 20.

FIG. 3 shows another principal view of a disc brake 1. The disc brake 1 has a brake caliper 4 in which a retaining element 12 is arranged, wherein the primary retaining area 14 is accommodated in an Opening in the brake caliper 4 which extends in the longitudinal direction L. The secondary retaining area 16 of the retaining element 12, on the other hand, is attached to the brake caliper 4 via a bolt connection or fixing device. A sensor element 50 is fixed to the retaining element 12 in the longitudinal direction L between the primary area 14 and the secondary area 16, wherein the sensor element 50 is connected to a cable arrangement 52. The sensor element 50 is a temperature measurement sensor which operates without contact. The sensor element 50 is designed such that this can detect the temperature of the brake pads 8, so that the sensor element 50 is a brake pad temperature measuring element. In addition, the sensor element 50 can also measure the brake disc temperature, so that the sensor element 50 is also a brake disc temperature measuring element.

### LIST OF REFERENCE SIGNS

1—Disc brake
2—Brake caliper assembly
4—Brake caliper
6—Insertion opening
8—Brake pad
10—Brake pad retainer assembly
12—Retaining element
14—Primary retaining area
16—Secondary retaining area
18—Bracket
20—Brake disc
22—Brake cylinder
50—Sensor element
52—Cable arrangement
54—Cable connector
L—Longitudinal direction

1.-15. (canceled)

16. A brake pad retainer assembly for a commercial vehicle brake caliper assembly, comprising:
a retaining element; and
a sensor element,
wherein the retaining element extends in a longitudinal direction;
wherein the sensor element is fixed or is configured to be fixed indirectly and/or directly to the retaining element; and
wherein the sensor element includes a temperature measurement sensor.

17. The brake pad retainer assembly according to claim 16, wherein the retaining element has a primary retaining area and a secondary retaining area, the primary retaining area and the secondary retaining area configured to support the retaining element relative to a brake caliper or brake caliper assembly, and wherein the sensor element is arranged between the primary retaining area and the secondary retaining area.

18. The brake pad retainer assembly according to claim 17, wherein the sensor element is arranged between the primary retaining area and the secondary retaining area in the longitudinal direction.

19. The brake pad retainer assembly according to claim 16, wherein the retaining element includes a pad retaining bracket.

20. The brake pad retainer assembly according to claim 16, wherein the sensor element includes a non-contact sensor.

21. The brake pad retainer assembly according to claim 16, wherein the sensor element is connected to a cable arrangement, and wherein the cable arrangement is fastened to the retaining element.

22. The brake pad retainer assembly according to claim 21, wherein the cable arrangement is fastened to the retaining element via one or more clips.

23. A brake caliper assembly comprising a brake caliper and the brake pad retainer assembly according to claim 16.

24. The brake caliper assembly according to claim 23, wherein the brake caliper has an insertion opening for inserting one or more brake pads, and wherein the retaining element is mounted or configured to be mounted on the brake caliper by the primary retaining area and the secondary retaining area such that the insertion or removal of one or more brake pads from or into the insertion opening of the brake caliper is positively prevented by the retaining element.

25. The brake caliper assembly according to claim 23, further comprising:
two brake pads.

26. The brake caliper assembly according to claim 25, wherein the sensor element is arranged on the side of the retaining element facing the brake pads.

27. The brake caliper assembly according to claim 25, further comprising:
a wear sensor configured to measure or detect a state of wear of the brake pads.

28. The brake caliper assembly according to claim 27, wherein the wear sensor is arranged indirectly or directly on the brake pad.

29. The brake caliper assembly according to claim 27, wherein the wear sensor is connected to a cable, and wherein the cable is attached to the retaining element.

30. The brake caliper assembly according to claim 23, wherein the sensor element includes a brake pad temperature measuring element and/or a brake disc temperature measuring element.

31. A disc brake comprising the brake caliper assembly according to claim 23 and a brake disc.

32. A disc brake monitoring system comprising the disc brake according to claim 31 and an evaluation unit, wherein the evaluation unit outputs and/or displays a warning if the temperature of the brake disc and/or brake pads is below an expected and/or above an expected temperature.
